(19) United States
(12) Patent Application Publication
(10) Pub. No.: US 2005/0209979 A1
(43) Pub. Date: Sep. 22, 2005

(54) Methods and apparatus for processing business reply mail

(76) Inventor: Jeffrey S. Poulin, Endicott, NY (US)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/803,856

(22) Filed: Mar. 18, 2004

(51) Int. Cl. G06F 17/00

(52) U.S. Cl. 705/406

(57) ABSTRACT

A system and method for processing business reply mail is provided wherein a stream of mail including business reply mail pieces is received at a mail processing facility. The business reply mail pieces are identified in the stream of mail and information from the business reply mail pieces is extracted. This information may be stored in electronic form and sent to the originating entity of the business reply mail piece. The physical business reply mail piece need not be delivered to the originating entity because the information contained thereon may be sent electronically.

### FIELD OF THE INVENTION

The invention relates generally to methods and apparatus for processing mail and, more particularly, to methods and apparatus for processing business reply mail.

### DISCUSSION OF THE RELATED ART

Business reply mail has a wide variety of uses. For example, companies often use business reply mail to collect information, solicit business, and/or collect remittance payments from recipients. Such business reply mail may be sent out in very large quantities, for example in a mass-mailing or as inserts in a magazine or newspaper. Consequently, in response to initiating a business reply mail campaign, the original sender may receive a large quantity of replies from the original recipients of the business reply mail.

These replies may include information requested by the originating entity (i.e., the company or individual that issued the business reply mail piece) or may include requests from the consumer (i.e., the original recipient of a business reply mail piece) for additional information. However, due to the large number of replies, processing and responding to the information included in each reply may be a difficult and tedious, and may require sorting through the reply mail pieces by hand or using dedicated equipment specially designed to automatically handle business reply mail pieces. To ease this burden, many originating entities hire third party vendors to receive the business mail replies and process the information included in those replies.

Before such information can be processed by the third party vendor, however, the business reply mail pieces must be received from the consumers at a mail processing facility through the regular stream of mail, identified as business reply mail, separated out from the general mail stream, grouped with other business reply mail pieces going to the same originating entity, and delivered to the third part vendor. Further, because the postage of the business reply mail pieces is paid for by the originating entity based on the number of business reply mail pieces returned by consumers, the postal service must count the number of replies that were mailed back to the originating entity to determine how much to charge the entity for the postage of the replies. Counting the number of reply mail pieces is also a tedious task. Because of the large number of business reply mail pieces typically sent out in a mailing, obtaining an accurate count may be difficult. Such counting is typically performed after the reply mail pieces have been separated out of the general mail stream, by either counting the mail pieces by hand or by using dedicated equipment specially designed to handle and count business reply mail pieces.

### SUMMARY OF THE INVENTION

One illustrative embodiment is directed to a method of processing business reply mail, comprising acts of: receiving a stream of mail pieces that includes at least one business reply mail piece and at least one non-business reply mail piece; automatically identifying the at least one business reply mail piece in the stream of mail pieces; and in response to the act of identifying the at least one business reply mail piece, automatically reading information on the at least one business reply mail piece. Another illustrative embodiment is directed to at least one computer readable medium encoded with instructions that, when executed on a computer system, perform the above-described method.

A further illustrative embodiment is directed to a sorting apparatus comprising: at least one feeder unit that receives a stream of mail pieces that includes at least one business reply mail piece and at least one non-business reply mail piece; and at least one controller that: automatically identifies the at least one business reply mail piece in the stream of mail pieces; and in response to identifying the at least one business reply mail piece, automatically reads information on the at least one business reply mail piece.

### BRIEF DESCRIPTION OF THE DRAWINGS

FIG. 1 is a diagram illustrating an example of distribution and return of business reply mail;

FIG. 2A is a diagram illustrating an example of the front side of a business reply mail piece, in accordance with one embodiment of the invention;

FIG. 2B is a diagram illustrating an example of the reverse side of a business reply mail piece, in accordance with one embodiment of the invention;

FIG. 3 is a block diagram of a sorting apparatus on which embodiments of the invention may be implemented;

FIG. 4 is a flow chart illustrating an example of a method for processing business reply mail pieces in a general mail stream, in accordance with one embodiment of the invention; and

FIG. 5 is a diagram illustrating an example of a network configuration by which business reply mail information may be sent back to an originating entity, in accordance with one embodiment of the invention.

### DETAILED DESCRIPTION

One embodiment of the invention is directed to receiving a stream of mail that includes a variety of different types of mail pieces to be sorted and delivered to their final destinations. The stream of mail includes one or more business reply mail pieces and one or more non-business reply mail pieces. As the stream of mail is being sorted, the one or more business reply mail pieces may be identified in the mail stream and information about the business reply mail piece may be captured and stored electronically.

Identifying and processing business reply mail pieces in the regular stream of mail during initial image lift (i.e., when the business reply mail pieces are first sorted) obviates the need for originators of business reply mail to process physical mail pieces. Further, the cost to the deliverer of the business reply mail pieces (e.g., the postal service) of processing the mail may be reduced because physical delivery of the mail pieces may not be required after the information on the business reply mail pieces has been extracted. That is, after initial image lift, a physical business reply mail piece may be removed from the mail stream without further sorting or processing and the information extracted from the business reply mail piece may be transferred electronically to the intended recipient. Additionally, such identifying and processing of business reply mail pieces may shorten the response time when sending fulfillment materials. Fulfillment materials are printed materials or products that are sent to a consumer in response to a business reply mail piece returned from the consumer that requests or indicates an interest in the materials. Because the addresses of consumers requesting fulfillment materials may be determined at a mail processing facility (e.g., by extracting the addresses from the business reply mail pieces), these addresses may be printed on the fulfillment materials and mailed from the mail processing facility without requiring that the originating entity receive the business reply mail pieces from the deliverer (e.g., the postal service), process the business reply mail pieces to determine which consumers are to receive fulfillment materials, address the fulfillment materials to those consumers, and then return the addressed fulfillment materials to the postal service for processing.

It should be appreciated that the benefits of embodiments of the invention described above are given only as examples. It should further be understood that embodiments of the invention may provide all, some, or none of these benefits, and the invention is not limited to providing any or all of these benefits.

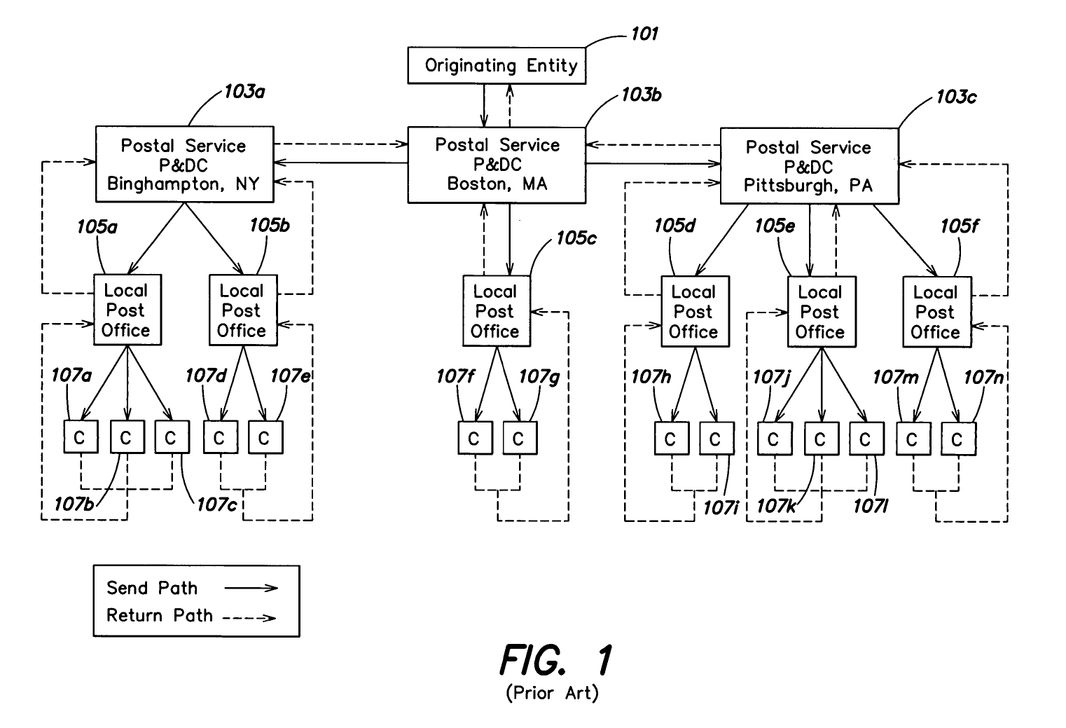

FIG. 1 is an example of a prior art method of distributing and receiving business reply mail pieces. In the example of FIG. 1, an originating entity 101, located in Boston, Mass., sends a number of business reply mail pieces to consumers 107a-107n. Mail pieces are received at a processing and distribution center (P&DC) where they are sorted based on their destination. Once sorted at the P&DC, the mail pieces are delivered to another P&DC (e.g., in another city) or the appropriate local post office. After the mail pieces are received at the local post office, they are again sorted based on in which mail delivery route the destination of the mail piece is located. From the local post office, the mail pieces are delivered to their final destinations.

For example, in FIG. 1, business reply mail pieces sent by originating entity 101 are received at a postal service P&DC 103b in Boston, where they are processed and sorted. In the example of FIG. 1, some of the business reply mail pieces are addressed to consumers served by a P&DC 103a Binghamton, N.Y., some are addressed to consumers served by P&DC 103b in Boston and other are addressed to consumers served by P&DC 103c in Pittsburgh, Pa.

The business reply mail pieces addressed to consumers served by P&DC 103b are sent from P&DC 103b to a local post office 105c and then are subsequently delivered to consumers 107f and 107g. The business reply mail pieces going to consumers served by P&DC 103a in Binghamton are first sent from P&DC 103b in Boston to P&DC 103a in Binghamton. These mail pieces are then delivered to local post offices 105a and 105b and then delivered from these local post offices to consumers 107a, 107b, 107c, 107d, and 107e. Similarly, the business reply mail pieces going to consumers served by P&DC 103c in Pittsburgh are first delivered to P&DC 103c from P&DC 103a in Boston. From P&DC 103c, the business reply mail pieces are delivered to local post office 105d, 105e, and 105f. Finally, the business reply mail pieces are delivered from the local post offices 105d-f to consumers 107h, 107I, 107j, 107k, 107l, 107m, and 107n.

When consumers 107a-107n return the business reply mail pieces to the originating entity, the business reply mail pieces follow the same path in reverse. That is, the mail pieces enter the mail stream at the local post office. From the local post office, the mail pieces are delivered to the P&DC serving the area. That is, mail from local post offices 105a and 105b is delivered to P&DC 103a, mail from local post office 105c is delivered to P&DC 103b, and mail from local post offices 105d, 105e, and 105f, is delivered to P&DC 103c. Next, the mail pieces are delivered to the P&DC that serves the originating entity. In the example of FIG. 1, originating entity 101 is served by P&DC 103b. Thus, the business reply mail pieces are sent from P&DC 103a and 103c to P&DC 103b. The business reply mail pieces are then delivered from P&DC 103b (either directly or through a local post office) to originating entity 101. The business reply mail pieces may then be processed by the originating entity.

In one embodiment of the invention, business reply mail pieces that are returned by a consumer need not be physically delivered to the originating entity. For example, a consumer may return a business reply mail piece to the originating entity by mailing it through a deliverer, such as the United States Postal Service (USPS). The deliverer may receive the business reply mail piece in the stream of mail and sort it along with other mail pieces in the stream of mail. During the sorting process, equipment used to automatically sort the mail may identify the business reply mail piece as a business reply mail piece, capture one or more images of the business reply mail piece, extract information about the business reply mail piece from the captured image or images, and store the captured information electronically. Once the image or images of the business reply mail piece have been captured, the business reply mail piece need not be further processed and the information extracted from the image of images of the business reply mail piece may be submitted electronically to the originating entity.

In another embodiment, processing and delivery of a physical business reply mail piece may continue after the image of the business reply mail piece has been captured. However, the recognition of the business reply mail piece in the general mail stream may be used to maintain a count of returned business reply mail pieces associated with a particular originating entity. The count may be used for billing the originating entity for the postage of the returned business reply mail pieces.

In the example of FIG. 1, business reply mail pieces returned by the consumer were first transferred from the consumer to a local post office and then from the local post office to one or more processing and distribution centers before being returned to the originating entity. By contrast, the above-described embodiment allows return delivery of a physical business reply mail piece to end after one or more images of the business reply mail piece is captured. Such extraction may be performed, for example, by automated sorting equipment used to sort mail pieces in the general mail stream. This equipment may be located at any mail processing facility. For example, the equipment may be located at postal service P&DC. In this case, once the business reply mail piece is processed at the P&DC, further delivery of the business reply mail piece is not required. Thus, unlike the example of FIG. 1 in which return business reply mail pieces sent by a consumer and received at P&DC 103a in Binghamton were subsequently sent to P&DC 103b in Boston before being returned to originating entity 101, delivery of the physical business reply mail piece may end once the business reply mail piece is processed at the P&DC in Binghamton. Alternatively, the automated sorting equipment that performs the image capture may be located at a local post office. In this case, physical delivery of a business reply mail piece may end once image capture of the mail piece is performed at the local post office.

It should be appreciated that a local post office and a P&DC are provided only as example of locations at which image capture of a business reply mail piece may occur and the invention is not limited in this respect. Indeed, such image capture may be performed at any mail processing facility or at any other suitable location. Further, it should be understood that the location at which image capture is performed is not limited to mail processing facilities of government postal services, such as the USPS. Indeed, the location of image capture may be any private or government sorting/processing facility, for example facilities of the United States government, facilities of foreign governments, and facilities of any private mail or parcel delivery services.

As discussed above, a business reply mail piece may be identified in a general mail stream and an image of the business reply mail piece may be captured and processed. In one embodiment of the invention, the deliverer (e.g., the USPS) of the business reply mail piece receives a stream of mail at a mail processing facility. Mail pieces in the stream of mail may be sorted using a sorting machine, such as a multi-line optical character reader (MLOCR). The MLOCR captures images of mail pieces and determines the destination of mail pieces by extracting destination information (e.g., zip code and/or street address) from the mail pieces using optical character recognition or other image processing techniques. In one embodiment of the invention, the MLOCR may identify a mail piece as a business reply mail piece by recognizing indicia on the business reply mail piece.

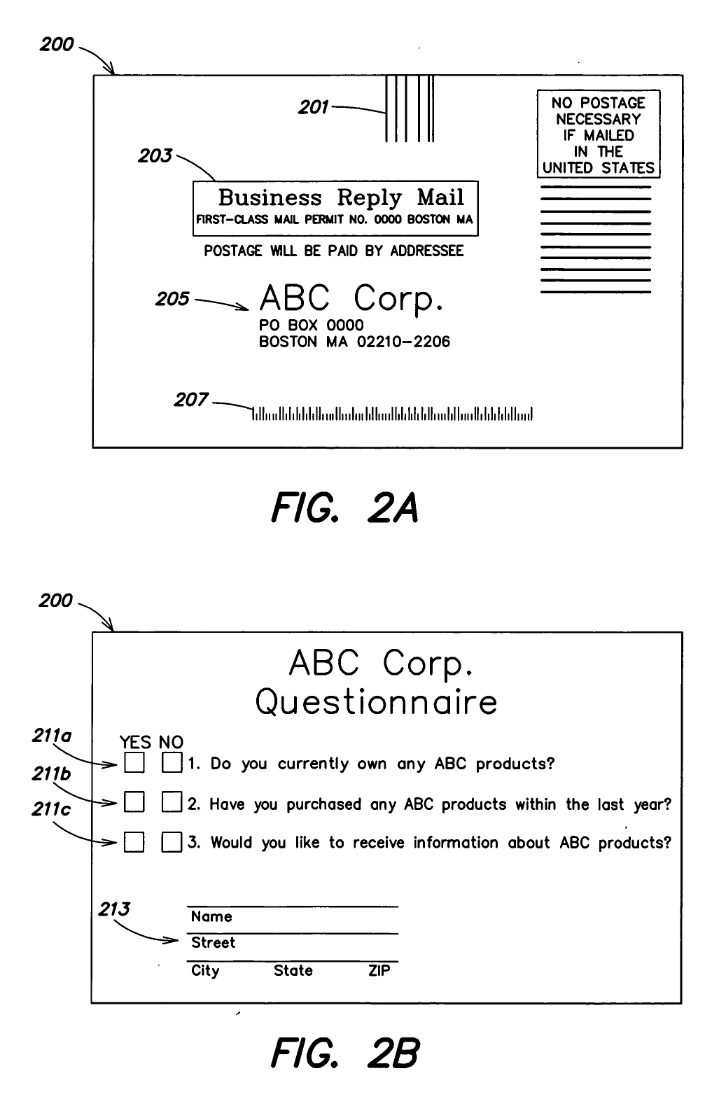

FIGS. 2A illustrates an example of the front side of a business reply mail piece 200. The front side of business reply mail piece 200 includes facial indicia markings 201, license plate 203, address information 205, and POSTNET barcode 207. Facial indicia markings 201 identify the mail piece as a business reply mail piece. License plate 203 provides the permit number for business reply mail piece. Address information 205 and POSTNET barcode 207 identify the originating entity and the destination of the business reply mail piece.

Identification of a business reply mail piece in the general stream of mail may be performed in any suitable manner. For example, the business reply mail piece may be identified by recognition of facial indicia markings 201 in the capture image of the business reply mail piece. Alternatively, the business reply mail piece may be identified by recognition of the license plate 203. As another example, the business reply mail piece may be identified by determining the destination of the business reply mail piece from the captured image or images using address information 205 or POSTNET barcode 207 and then performing a database lookup of the destination to determine if the address is designated as a business reply mail address. Other suitable ways of identifying a business reply mail piece may also be used and the invention is not limited in this respect. For example the business reply mail piece may include other special indicia that identify it as a business reply mail piece.

It should be appreciated that the format of the front side of business reply mail piece 200 in FIG. 2A is provided only as an example and other suitable formats may be used. Further, the business reply mail piece need not include any or all of the information shown in FIG. 2A. Some of the information shown in FIG. 2A may be required by the deliverer of the business reply mail piece (e.g., the USPS), therefore it may be practical to use these elements to identify the business reply mail piece (i.e., because that information already exists on the mail piece). However, as long as a suitable way exists for identifying a mail piece as a business reply mail piece, none of the information shown on business reply mail piece 200 are required and the invention is not limited to including any or all of this information. It should further be understood that while in the above example the indicia used to identify the business reply mail piece were located on the front side of the business reply mail piece, the invention is not limited in this respect and such indicia may appear on either side of the business reply mail piece.

For example, the business reply mail piece may include other indicia such as barcodes, magnetic ink, fluorescent strips, or other marks which may be used to identify the mail piece as a business reply mail piece. In this respect, while embodiments of the invention may identify the business reply mail piece using a captured image of the business reply mail piece (e.g., by using optical character recognition techniques), the invention is not limited in this respect. Indeed, the business reply mail piece may be identified directly from the physical mail piece using, for example, barcode readers, magnetic ink readers, or any other suitable device.

In addition to identifying a mail piece as a business reply mail piece, information provided on the business reply mail piece may be extracted from the business reply mail piece (or an image of the business reply mail piece) and may be converted into electronic form. In one embodiment of the invention, one or more images of a business reply mail piece may be captured and information provided by the consumer returning the business reply mail piece may be extracted from the image using optical character recognition and/or image processing techniques. The business reply mail piece may employ a predefined layout to aid in the information extraction process. For example, FIG. 2B shows the reverse side of business reply mail piece 200. The layout of business reply mail piece 200 is predefined to include a series of yes or no checkboxes 211a, 211b, and 211c on the left hand side of the card and a series of lines 213 on which the consumer that returned the business reply mail piece may print his or her name and address.

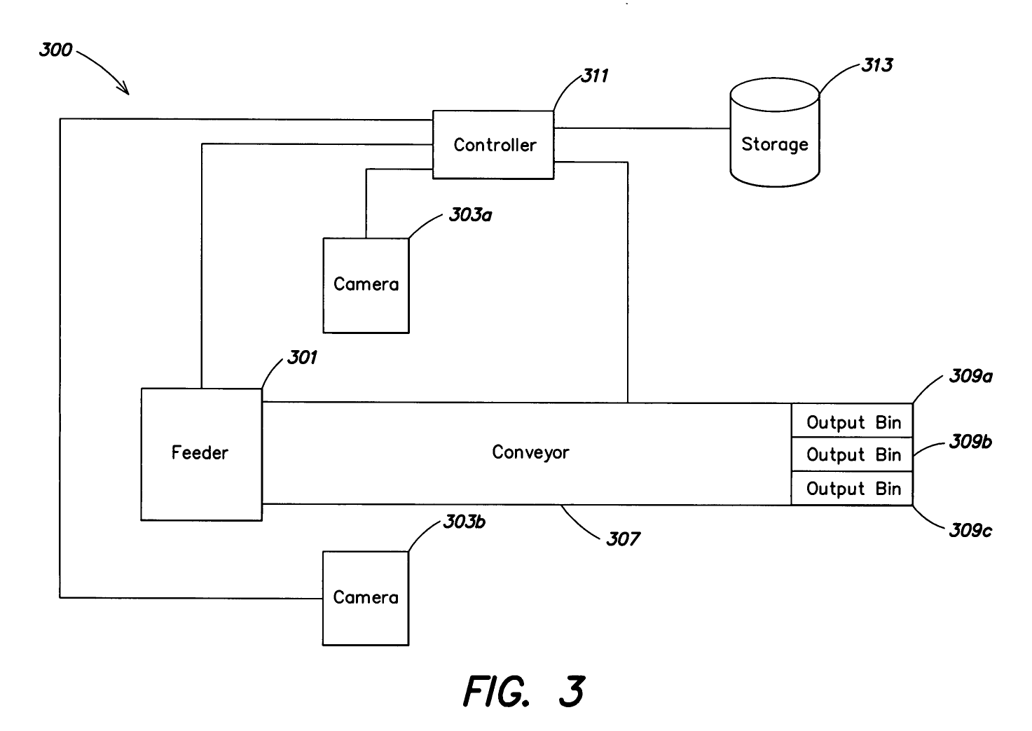

FIG. 3 is a simplified block diagram of a sorting apparatus 300 that may be used in embodiments of the invention. Sorting apparatus 300 includes a feeder unit 301 that feeds mail pieces onto conveyor 307. Cameras 303a and 303b capture images of mail pieces on conveyor 307 and send the images to controller 311. Controller 311 controls the operation of feeder unit 301, conveyor 307, and cameras 303a and 303b. Controller 311 receives images of mail pieces captured by cameras 303a and 303b, processes the images, and controls conveyor 307 to route the mail pieces into one of output bins 309a, 309b, and 309c, based on the results of processing the images. Controller 311 may also access storage device 313 to retrieve information stored on storage device 313 for use in processing images of mail pieces and to store images of mail pieces or information extracted from images of mail pieces.

In one embodiment, controller 311 may include one or more processors that extract software instructions to sort mail pieces and control the operation of sorting apparatus 300. For example, sorting apparatus 300 may include a computer system of which controller 311 forms a part. Thus, controller 311 may include hardware, software, or any combination thereof.

In FIG. 3, sorting apparatus 300 includes only one feeder unit (i.e., feeder unit 301). However, it should be appreciated that this is provided only as an example and the sorting apparatus may include multiple feeder units and the invention is not limited in this respect. Similarly, although only one conveyor is shown in FIG. 3, sorting apparatus may include multiple conveyors and the invention is not limited in this respect. Likewise, sorting apparatus 300 in FIG. 3 includes three output bins. However, this is provided only as an example, as any suitable number of output bins may be used and the invention is not limited in this respect.

Further, in FIG. 3, sorting apparatus 300 includes two cameras 303a and 303b, one on each side of conveyor 307. When configured in this manner, images of both sides of a mail piece may be captured as the mail piece passes by the cameras on conveyor 307. If it is desired to capture images of both sides of a mail piece using a sorting apparatus that includes only a single camera, the mail piece may be fed to sorting apparatus a first time to capture one side of the mail and then re-fed a second time to capture the other side of the mail piece. In some embodiments, however, it may be necessary to capture an image of only one side of a mail piece. Thus, sorting apparatus may include only a single camera or may include two or more cameras as the invention is not limited in this respect.

Storage device 313 may be part of sorting apparatus 300 or may be separate from the sorting apparatus and may include any type of storage medium such as, for example, magnetic disk(s), random access memory, magnetic tape, optical disc(s), and any other suitable storage medium.

It should further be appreciated that sorting apparatus 300 may include other components not shown in the simplified example of FIG. 3. Further, sorting apparatus 300 is provided only as an example of a sorting apparatus that may be used in some embodiments of the invention and any other suitable sorting apparatus may be used, as the invention is not limited in this respect.

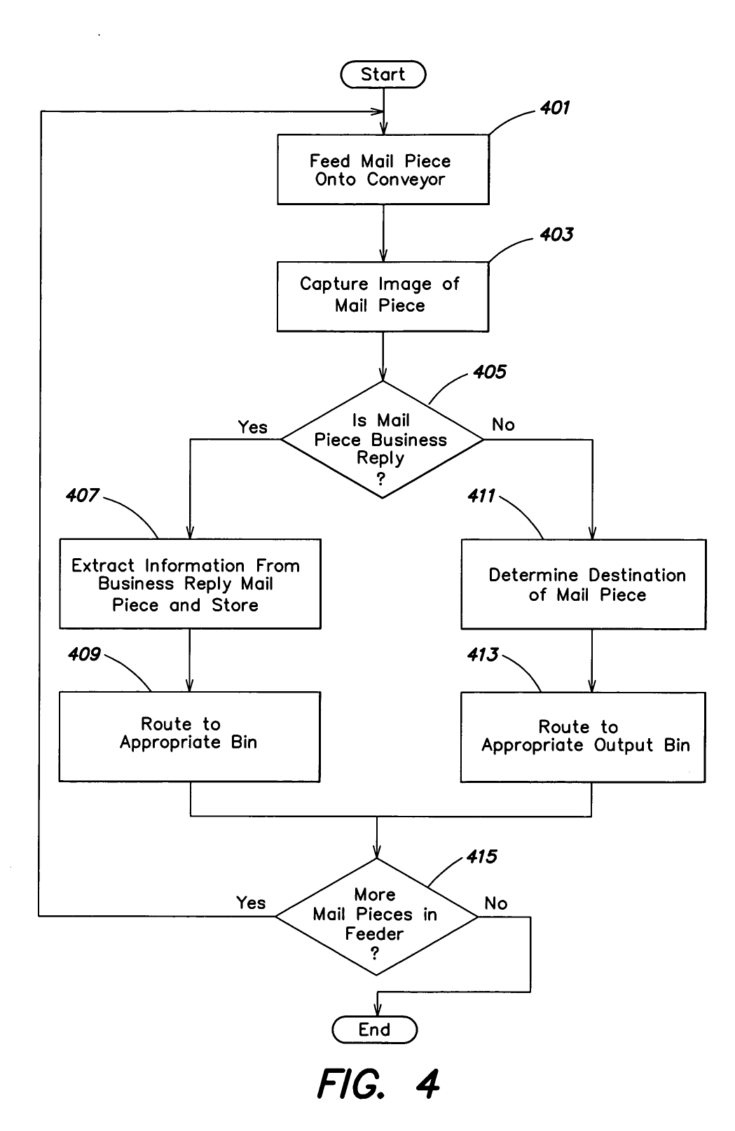

FIG. 4 is a flow chart illustrating an example of an algorithm, according to one embodiment of the invention, for processing mail pieces in a mail stream that includes one or more business reply mail pieces, for example, business reply mail piece 200, using a sorting apparatus, for example sorting apparatus 300. In act 401, a mail piece is fed from feeder unit 301 to conveyor 307. The process continues to act 403, where one or more images of the mail piece are captured, for example by camera 303a and/or camera 303b, as the mail piece passes by the cameras on the conveyor. The process then continues to act 405, where controller 311 receives the image(s) and determines if the mail piece is a business reply mail piece based on the image(s). This determination may be made in any suitable way. When controller 311 determines that the mail piece is a business reply mail piece, the process continues to act 407. At act 407, information from the image or images of the business reply mail piece may be extracted and stored. As discussed above, in one embodiment, the layout of the business reply mail piece may be predefined and controller 311 may recognize the predefined layout of the business reply mail piece. That is, for example, the location of the information on the mail piece that is to be extracted may be pre-programmed or hardwired into the controller.

It should be understood that the use of a predefined layout to recognize and extract information from a business reply mail piece is only one example of a manner in which information from a business reply mail piece may be extracted. Other ways of extracting information from a business reply mail piece may be used, such as, for example, using form-reading software to process an image of information written or printed on the business reply mail piece. Indeed, any suitable manner of extracting information written or printed on a business reply mail piece may be used and the invention is not limited in this respect.

The information extracted from the image or images of the mail piece may include, for example, information added to the mail piece by the consumer, such as the name and address of the consumer, and any checkboxes or other information marked on the mail piece by the consumer, information pre-printed on the card by the originating entity, such as, for example, the name of the originating entity, the destination of the mail piece, and the permit number. Alternatively, the information extracted from the image or images of the business reply mail piece may be, for example, the image or images themselves. It should be appreciated that the above are only examples of information that may be extracted from the image or images of the business reply mail piece and any other suitable information may be extracted, as the invention is not limited in this respect.

Information extracted from the image or images of the business reply mail piece may be stored on storage device 313. This information may later be transmitted electronically to the originating entity. Alternatively, the information need not be stored in storage device 313 and may be transmitted to the originating entity upon or directly after extraction from the image or images.

The process next continues to act 409 where the physical mail piece is directed to an appropriate output bin 309. Because physical business reply mail pieces need not be delivered to their destinations, business reply mail pieces may be directed to an output bin designated for mail to be discarded and/or recycled. Alternatively, the business reply mail piece may be sorted with the regular stream of mail and routed to the appropriate output bin based on its destination, for example, if the originating entity desires receipt of the business reply mail information in both electronic and physical form.

If, at act 405, it is determined that the mail piece is not a business reply mail piece, the process continues to act 411 where controller 311 may determine the destination of the mail piece, for example, from information in the image of the mail piece or from a POSTNET barcode printed on the mail piece. The process then continues to act 413 where controller 311 controls conveyor 307 to route the mail piece to the appropriate output bin 309 based on, for example, the destination of the mail piece.

The process next continues to act 415 where controller 311 determines if there are more mail pieces remaining in feeder 301. If more mail pieces remain in the feeder, then the process returns to act 401, where the controller again instructs the feeder unit to feed the next mail piece onto the conveyor. If no more mail pieces remain in the feeder, then the process ends.

As discussed above, embodiments of the invention may employ a predefined layout for business reply mail pieces to aid in the image processing and information extraction process. Business reply mail piece 200 in FIG. 2B provides an example of a business reply mail piece having a predefined layout. However, many other predefined layouts for business reply mail pieces may be used and the invention is not limited to any particular predefined layout.

It should be understood that the use of predefined layout to aid in the information extraction process is only one example of a way in which information may be extracted from a business reply mail piece in one embodiment of the invention. The invention is not limited to any particular manner of extracting information from a business reply mail piece as any suitable manner may be employed.

As discussed above, various types of information may be extracted from a business reply mail piece after it has been identified in the stream of mail. In one embodiment of the invention, a count of the number of returned business reply mail pieces associated with a particular originating entity is maintained and thus, the only information extracted from the business reply mail piece is the originating entity. The originating entity may be determined by the name printed on the business reply mail piece, the destination printed on the business reply mail piece, the POSTNET barcode on the business reply mail piece, or in any other suitable manner. In this embodiment, the originating entity is determined and a count of the number of returned business reply mail pieces belonging to that originating entity is maintained. This provides the deliverer with an accurate count of how many business reply mail pieces were returned so that the deliverer can determine with accuracy how much to charge the originating entity. The count of the number of returned business reply mail pieces also provides the originating entity with an indication of how much consumer interest was generated by the distribution of the business reply mail pieces.

In another embodiment, in addition to maintaining a count of the number of returned business reply mail pieces for a particular originating entity, additional information regarding how many business reply mail pieces were sent from different locations may be maintained. This information may provide the originating entity with an indication of how much consumer interest the business reply mail pieces generated based on geographic location. For example, assume an originating entity distributed 10,000 business reply mail pieces, of which 4,000 were returned. Of the 4,000 returned mail pieces, 2,000 were identified in the mail stream at a P&DC in Binghamton, 1000 were identified at a P&DC in Boston, and 1000 were identified at a P&DC in Philadelphia. Thus, in addition to maintaining the total count of 4,000 returned mail pieces, the count of returned business reply mail pieces for a particular mail processing facility may also be maintained.

In another embodiment, an originating entity may send a number of different types of business reply mail pieces targeted towards different groups of consumers. For example, an originating entity may distribute business reply mail pieces advertising sporting goods to groups of consumers who have an interest in sports and business reply mail pieces advertising artwork to groups of consumers who have an interest in art. When a business reply mail piece is returned by a consumer and processed at a mail processing facility, it may be determined what type of business reply mail piece it is (e.g., sporting goods or artwork). This information may be obtained, for example, by any indicia, such as, for example, a symbol, code, text, or glyph, that is pre-printed on the business reply mail piece and that indicates the type of the business reply mail piece. For example, business reply mail pieces advertising sporting goods may include an “s” printed in one corner of the mail piece while business reply mail pieces advertising artwork may include an “a” printed in one corner of the mail piece. It should be understood that the indicia described above are provided only as examples and that any suitable identifier that differentiates between types of business reply mail pieces may be used, as the invention is not limited in this respect. When an image of the business reply mail piece is captured (i.e., as part of the sorting process), the indicia may be recognized and a count of the number of returned business reply mail pieces of each type may be maintained. Additionally, in one embodiment, the count of the number of returned mail pieces of each type may also be broken down by the geographic location from which they were mailed, as described above.

In another embodiment, instead of or in addition to maintaining a count of business reply mail pieces broken down by type and/or geographic location, information printed on the card by the consumer may be extracted from an image or images of the mail piece and maintained. For example, the markings in checkboxes 211a, 211b, and 211c, in business reply mail piece 200 of FIG. 2B may be obtained to determine how the consumer responded to the corresponding questions. Further, the name and return address of the consumer printed on lines 213 of business reply mail piece 200 may also be extracted and maintained. This information may permit the originating entity to add the consumer to future mailing lists and/or to send fulfillment materials requested on the business reply mail piece to the consumer. Thus, a list of customer names, their addresses, and fulfillment materials/services requested may be maintained and provided electronically to the originating entity. In one embodiment, when an address of a consumer is extracted from the business reply mail piece, a database of known addresses may be accessed and compared to the extracted address to verify that the extracted address exists. Performing such verification of extracted addresses may save the originating entity the cost of sending requested fulfillment materials to addresses that do not exist.

In another embodiment, fulfillment materials may be held or printed at the mail processing facility at which the business reply mail piece is received. Thus, when it is determined from the business reply mail piece that a consumer has requested the fulfillment materials, the fulfillment materials may be sent directly from the mail processing facility to the address of the consumer extracted from the business reply mail piece. This improves the response time of sending fulfillment materials to consumers who requested them. The fulfillment materials may be sent in any suitable way at any suitable time and the invention is not limited in this respect. For example, fulfillment materials may be sent as soon as a business reply mail piece requesting those materials is processed or fulfillment materials may be sent in batches. If sent in batches, a batch of fulfillment materials may be sent, for example, when a certain number of business reply mail pieces requesting those materials are processed or after a certain amount of time has elapsed (e.g., once every five minutes).

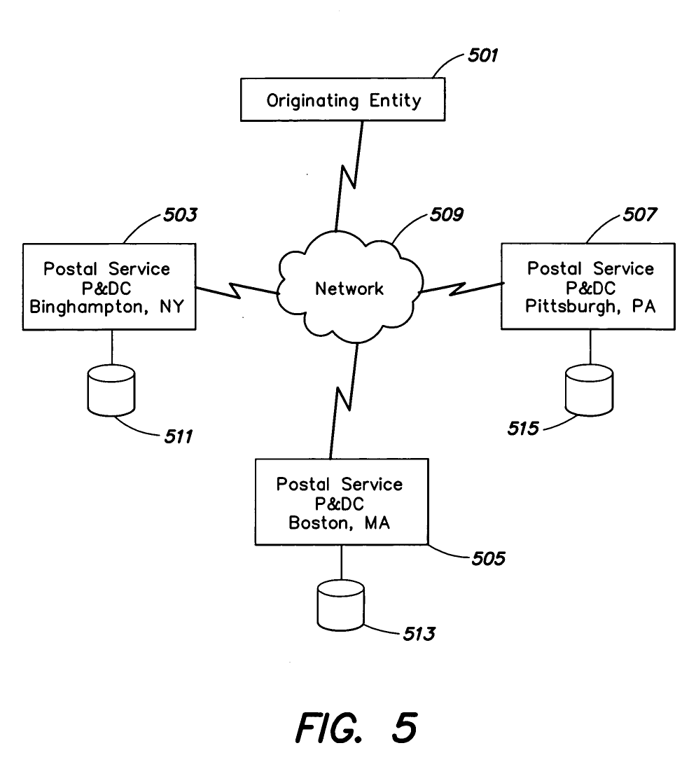

Information extracted from the business reply mail pieces may be sent to the originating entity in any suitable manner and the invention is not limited in this respect. In one embodiment of the invention, as shown in FIG. 5, originating entity 501 may communicate with P&DC 503 in Binghamton, P&DC 505 in Boston, and P&DC 507 in Pittsburgh over network 509. Each P&DC includes a storage device on which information extracted from the business reply mail pieces may be stored. For example, P&DC 503 includes storage device 511, P&DC 505 includes storage device 513, and P&DC 507 includes storage device 515. Network 509 may be any type of computer network or networks and may include, for example, a local area network, a wide area network, the Internet, or any combination of thereof. P&DCs 503, 505, and 507 may store a network address of originating entity 501 or the network address of originating entity 501 may be stored at a central location accessible to all P&DCs. The P&DCs may periodically transmit information extracted from business reply mail pieces stored on their respective storage devices to the network address of the originating entity associated with those business reply mail pieces.

Alternatively, information regarding business reply mail pieces may be stored in a central location accessible to all P&DCs (e.g., a designated one of the P&DCs or other central storage device) and information may be transmitted from the central storage device to the originating entity. In another embodiment, instead of P&DCs initiating the transmission of the information to the originating entity, the originating entity may periodically request information regarding business reply mail pieces and the P&DCs may respond with any information extracted from business reply mail pieces associated with that originating entity.

In another embodiment, the information is not sent electronically to the originating entity but instead is physically delivered. For example, the information may be printed out on paper and delivered to the originating entity or may be stored in electronic form on a portable storage medium (e.g., a magnetic or optical disk) and delivered to the originating entity.

The above described embodiments are directed primarily to the return of business reply mail pieces by consumers who have received them and the subsequent processing of those business reply mail pieces. However, it should be appreciated that the consumers may initially receive the business reply mail pieces in any suitable way and the invention is not limited in this respect. For example, the business reply mail pieces may be distributed in magazines or other publication, as part of an advertising campaign, or may be mailed directly to consumers.

The above-described embodiments of the present invention can be implemented in any of numerous ways. For example, the embodiments may be implemented using hardware, software or a combination thereof. When implemented in software, the software code can be executed on any suitable processor or collection of processors. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments of the present invention comprises at least one computer-readable medium (e.g., a computer memory, a floppy disk, a compact disk, a tape, etc.) encoded with a computer program (i.e., a plurality of instructions), which, when executed on a processor, performs the above-discussed functions of the embodiments of the present invention. The computer-readable medium can be transportable such that the program stored thereon can be loaded onto any computer system resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

The phraseology and terminology used herein is for the purpose of description and should not be regarded as limiting. The use of “including,” “comprising,” or “having,” “containing”, “involving”, and variations thereof herein, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

1. A method of processing business reply mail, comprising acts of:
receiving a stream of mail pieces that includes at least one business reply mail piece and at least one non-business reply mail piece;
automatically identifying the at least one business reply mail piece in the stream of mail pieces; and
in response to the act of identifying the at least one business reply mail piece, automatically reading information on the at least one business reply mail piece.

2. The method of claim 1, wherein the act of automatically identifying the business reply mail piece further comprises an act of:
distinguishing the at least one business reply mail piece from the at least one non-business reply mail piece.

3. The method of claim 1, wherein the act of automatically reading information on the at least one business reply mail piece further comprises acts of:
capturing at least one image of the at least one business reply mail piece; and
processing the at least one image to convert the information on the at least one business reply mail piece into electronic form.

4. The method of claim 1, wherein the act of automatically reading information on the at least one business reply mail piece further comprises an act of:
reading a barcode on the at least one business reply mail piece.

5. The method of claim 1, wherein the at least one business reply mail piece is addressed to an intended recipient and the method further comprises an act of:
discarding the at least one business reply mail piece without delivering the at least one business reply piece to the intended recipient.

6. The method of claim 1, further comprising an act of:
storing the information in electronic form.

7. The method of claim 1, wherein the business reply mail piece is associated with an originating entity and the method further comprises an act of:
receiving the information at the originating entity.

8. The method of claim 7, wherein the act of sending the information to the originating entity further comprises an act of sending the information to the originating entity in electronic form.

9. The method of claim 1, wherein the acts of receiving, automatically identifying, and automatically reading are performed at a mail processing facility.

10. The method of claim 9, wherein the information includes a return address of a sender of the at least one business reply mail piece and a request for additional materials, and wherein the method further comprises act of:
identifying the request for additional materials; and
in response to identifying the request, sending the additional materials from the mail processing facility to the sender.

11. At least one computer readable medium encoded with instructions that, when executed on a computer system perform a method of processing business reply mail, the method comprising acts of:
receiving a stream of mail pieces that includes at least one business reply mail piece and at least one non-business reply mail piece;
automatically identifying the at least one business reply mail piece in the stream of mail pieces; and
in response to the act of identifying the at least one business reply mail piece, automatically reading information on the at least one business reply mail piece.

12. The at least one computer readable medium of claim 11, wherein the act of automatically identifying the business reply mail piece further comprises an act of:
distinguishing the at least one business reply mail piece from the at least one non-business reply mail piece.

13. The at least one computer readable medium of claim 11, wherein the act of automatically reading information on the at least one business reply mail piece further comprises acts of:
capturing at least one image of the at least one business reply mail piece; and
processing the at least one image to convert the information on the at least one business reply mail piece into electronic form.

14. The at least one computer readable medium of claim 11, wherein the act of automatically reading information on the at least one business reply mail piece further comprises an act of:
reading a barcode on the at least one business reply mail piece.

15. The at least one computer readable medium of claim 11, wherein the at least one business reply mail piece is addressed to an intended recipient and the method further comprises an act of:
discarding the at least one business reply mail piece without delivering the at least one business reply piece to the intended recipient.

16. The at least one computer readable medium of claim 11, further comprising an act of:
storing the information in electronic form.

17. The at least one computer readable medium of claim 11, wherein the business reply mail piece is associated with an originating entity and the method further comprises an act of:
receiving the information at the originating entity.

18. The at least one computer readable medium of claim 17, wherein the act of sending the information to the originating entity further comprises an act of sending the information to the originating entity in electronic form.

19. The at least one computer readable medium of claim 11, wherein the acts of receiving, automatically identifying, and automatically reading are performed at a mail processing facility.

20. The at least one computer readable medium of claim 19, wherein the information includes a return address of a sender of the at least one business reply mail piece and a request for additional materials, and wherein the method further comprises act of:
identifying the request for additional materials; and
in response to identifying the request, sending the additional materials from the mail processing facility to the sender.

21. A sorting apparatus comprising:
at least one feeder unit that receives a stream of mail pieces that includes at least one business reply mail piece and at least one non-business reply mail piece; and
at least one controller that:
automatically identifies the at least one business reply mail piece in the stream of mail pieces; and
in response to identifying the at least one business reply mail piece, automatically reads information on the at least one business reply mail piece.

22. The sorting apparatus of claim 21, wherein the at least one controller:
distinguishes the at least one business reply mail piece from the at least one non-business reply mail piece.

23. The sorting apparatus of claim 21, wherein the sorting apparatus includes at least one camera that captures at least one image of the at least one business reply mail piece and wherein the at least one controller processes the at least one image to convert the information on the at least one business reply mail piece into electronic form.

24. The sorting apparatus of claim 21, wherein the act sorting apparatus further comprises a barcode reader that reads a barcode on the at least one business reply mail piece.

25. The sorting apparatus of claim 21, wherein the sorting apparatus further comprises at least one output bin that receives mail pieces to be discarded, and wherein the at least one controller routes the at least one business reply mail piece to the at least one output bin.

26. The sorting apparatus of claim 21, wherein the at least one controller stores the information in electronic form.

27. The sorting apparatus of claim 21, wherein the business reply mail piece is associated with an originating entity and the at least one controller sends the information to the originating entity.

28. The sorting apparatus of claim 27, wherein the at least one controller sends the information to the originating entity in electronic form.

29. The sorting apparatus of claim 21, wherein the business reply mail piece is associated with an originating entity and the at least one controller receives a request for the information from the originating entity.

30. The sorting apparatus of claim 21, located at a mail processing facility.

31. The sorting apparatus of claim 21, wherein the information includes an address of an initial recipient of the business reply mail piece.
